(19) United States
(12) Patent Application Publication
(10) Pub. No.: US 2026/0077350 A1
(43) Pub. Date: Mar. 19, 2026

(54) CARTRIDGE FOR LAB-ON-CHIP APPLICATIONS

(71) Applicant: STMICROELECTRONICS INTERNATIONAL N.V., Geneva (CH)

(72) Inventors: Davide CUCCHI, Brugherio (IT); Erika GALBUSERA, Osnago (IT); Arash SASANIAN, Milano (IT); Marco Angelo BIANCHESSI, Melzo (IT); Alessandro Paolo BRAMANTI, Maglie (IT)

(21) Appl. No.: 19/317,344

(22) Filed: Sep. 3, 2025

(30) Foreign Application Priority Data
Sep. 13, 2024 (IT) 102024000020491

(51) Int. Cl. B01L 3/00

(52) U.S. Cl. CPC B01L 3/502715; B01L 3/5029; B01L 2200/028; B01L 2200/0689; B01L 2200/16; B01L 2300/042; B01L 2400/0487

(57) ABSTRACT

The present disclosure provides a cartridge for Lab-On-Chip applications. An example cartridge for Lab-On-Chip applications includes a first module that is including: at least one desiccant storage chamber, a dry-reagent storage chamber, a fluidic circuit fluidically connected to the dry-reagent storage chamber, a first air path connecting the dry-reagent storage chamber to the desiccant storage chamber and comprising a membrane that prevents liquid flow from the dry-reagent storage chamber to the desiccant storage chamber. The cartridge further comprises a second module including a container having an internal cavity for holding a liquid solution. The first module and the second module are adapted to be fluidically coupled to one another.

### CROSS REFERENCE TO RELATED APPLICATION(S)

This application claims the priority benefit of Italian patent application number 102024000020491, filed on Sep. 13, 2024, entitled “CARTUCCIA PER APPLICAZIONI LAB-ON-CHIP”, which is hereby incorporated by reference to the maximum extent allowable by law.

### TECHNICAL FIELD

The present invention relates to a cartridge for sample preparation and analysis of molecules. In particular, the present invention relates to the field of so-called Lab-On-Chip (LOC) devices, in which a single cartridge comprises structures designed to perform at least some steps of processing a sample for the purpose of extracting and analyzing molecules.

### BACKGROUND

Lab-On-Chip (LOC) systems are known, in particular LOC systems relying on the use of cartridges (for example disposable cartridges) that are put in a machine which carries out analysis of the substances contained in the cartridges, in general after a pre-treatment. Such systems are of great importance for health, importance that increases in time together with the number of analyses that can be performed in a simple way by a patient alone or with the aid of not particularly skilled persons.

In particular, the above systems enable analysis of biological molecules, such as nucleic acids, proteins, lipids, polysaccharides, etc. These analyses comprise a plurality of operations that start from a raw material, for example a blood or a saliva sample, or a sample collected by a nasal swab (nasal sample). These operations may include various degrees of sample pre-treatment, lysis, purification, amplification, and analysis of the resulting product. The analysis methods vary as a function of the target biological molecule that is to be analyzed or detected. Furthermore, LOC systems may be used also for the purification of non-biological samples, such as water samples, and for the analysis of non-biological molecules.

The operations involved in the treatment and analysis of the sample require specific reagents. For instance, nucleic acids analyses, such as analyses based on Clustered Regularly Interspaced Short Palindromic Repeats (CRISPR), Polymerase Chain Reaction (PCR), Ligase Chain Reaction (LCR), Strand-Displacement Amplification (SDA), Transcription-Mediated Amplification (TMA), Rolling-Circle Amplification (RCA), Loop-mediated isothermal amplification (LAMP) and the like, requires specific enzymes to carry out steps of amplification and/or target recognition. As another example, in proteomic analyses like Enzyme-Linked Immunosorbent Assay (ELISA) analyses, antibodies and enzymes suitable for selectively binding a target analyte of interest are required to carry out a detection.

Reagents may be stored in liquid or solid form (for example lyophilized or freeze-dried or dried) depending on their nature. The solid form reagents (referred to as “dry reagents” in the following), for example the lyophilized enzymes in the case of a CRISPR based analyses, require being stored in a dry environment to prevent undesired hydration. Indeed, hydration of the dry reagents must take place during the analysis or pre-treatment of the sample at specific, predetermined steps depending on their function. Premature, unwanted hydration would in fact accelerate the dry reagents degradation, therefore reducing their shelf-life.

A known solution to prevent the premature hydration of the dry reagents consists in storing them in specific chambers created within the LOC cartridge. The LOC cartridge is then packaged inside an external sealed container or package which accommodates a desiccant (for example a bag containing silica beads or silica gel) together with the cartridge. The container may further be filled with dry inert gases, for example nitrogen (N2) or argon (Ar).

The cartridge is then stored inside the sealed package with the desiccant throughout its shelf-life, until its use. However, humidity may (by chance) enter the package and penetrate inside the cartridge, or it may be present inside the cartridge for example from before the packaging step, hydrating and deteriorating the dry reagents.

Another possible cause of the hydration, and thus of the deterioration, of the dry reagents can arise during the early steps of the analysis to be carried out. For example, during the above mentioned CRISPR based analysis, a lysis step is required to extract the nucleic acids from the cells present in a biological sample, which is usually diluted in an aqueous buffer. The lysis step can be performed by heating the biological sample in the presence of specific reagents, therefore causing evaporation of part of the aqueous buffer. The resulting vapor may then reach the dry reagents, hydrating and possibly degrading them before their intended use.

Therefore, the need is felt to provide for a cartridge allowing a more effective and safe storage of dry reagents until their use.

### BRIEF SUMMARY

According to the present invention, a cartridge for Lab-On-Chip applications is provided.

In one example embodiment, a cartridge for Lab-On-Chip applications is provided. The cartridge for Lab-On-Chip applications comprises: a first module including: at least one desiccant storage chamber; a dry-reagent storage chamber; a fluidic circuit, fluidically connected to the dry-reagent storage chamber; a first air path connecting the dry-reagent storage chamber to the desiccant storage chamber and comprising a membrane that is impermeable to liquids and permeable to gases and vapors, the membrane being arranged in the first air path in such a way to prevent liquid flow from the dry-reagent storage chamber to the desiccant storage chamber; a second module including a container having an internal cavity for holding a liquid solution; wherein the first module and the second module have a respective first and second fluidic connector adapted to be fluidically coupled to one another; and wherein the first connector of the first module is fluidically coupled to the fluidic circuit and the second connector of the second module is fluidically coupled to the container.

In various embodiments, the cartridge for Lab-On-Chip applications further comprises one or more desiccants in the desiccant storage chamber and one or more dry reagents in the dry-reagent storage chamber.

In various embodiments, the first module comprises a first layer and a second layer coupled to one another; wherein the first air path comprises: a first portion in the first layer, fluidically connected to the dry-reagent storage chamber; a second portion in the second layer; a third portion in the first layer, fluidically connected to the desiccant storage chamber; a first through hole extending through the first layer, fluidically connected to the first portion of the first air path and aerially coupled to the second portion of the first air path via the membrane; and a second through hole extending through the first layer, fluidically connected to the third portion of the first air path and aerially coupled to the second portion of the first air path via the membrane.

In various embodiments, the first module comprises a first layer having a first face and a second face opposite to one another; wherein the first air path comprises: a first portion at the first face of the first layer, fluidically connected to the dry-reagent storage chamber; a second portion at the second face of the first layer; a third portion at the first face of the first layer, fluidically connected to the desiccant storage chamber; a first through hole extending through the first layer from the first to the second face, fluidically connected to the first portion of the first air path and aerially coupled to the second portion of the first air path via the membrane; and a second through hole extending through the first layer from the first to the second face, fluidically connected to the third portion of the first air path and aerially coupled to the second portion of the first air path via the membrane.

In various embodiments, the first module comprises a second layer and a third layer; wherein the second layer includes a tape or film coupled to the first face of the first layer, configured to seal the fluidic circuit, the desiccant storage chamber, and the dry-reagent storage chamber; and wherein the third layer includes at least one tape or film coupled to the second face of the first layer and at least one heating element of semiconducting material coupled to the second face of the first layer.

In various embodiments, the first module and the second module have respective mechanical coupling means for mechanically coupling the first module to the second module.

In various embodiments, the first and second fluidic connectors are Luer connectors.

In various embodiments, the container is a sample collection container comprising a swab having a tip, a shaft coupled to the tip, and a cap coupled to shaft; wherein the container has a threaded opening for insertion of the swab in the cavity; wherein the cap of the swab is a threaded cap suitable for sealing the cavity when the swab is inserted in the container and the threaded cap is screwed on the threaded opening; and wherein the container includes a first portion of deformable material configured to undergo an elastic deformation when an internal pressure is exerted.

In various embodiments, the container includes a second portion provided with protrusions inside the cavity such that, when the swab is inserted into the container, the tip comes in contact with the protrusions; and the second portion being configured to be withstand said internal pressure without deformation.

In various embodiments, the second fluidic connector includes a passing hole through the container at said second portion, said elastic deformation being caused, during use, by pumping the liquid solution out of the container.

In various embodiments, the cartridge for Lab-On-Chip applications further comprises a second air path, aerially connecting the desiccant storage chamber to an outlet opening of the cartridge, said outlet opening being configured for being connected to external control means for air sucking.

In various embodiments, a sealing layer coupled to the first module to seal the fluidic circuit, the desiccant storage chamber, and the dry-reagent storage chamber.

In various embodiments, the fluidic circuit includes: a reaction chamber; a first fluidic channel fluidically connecting the first fluidic connector to the reaction chamber; and a second fluidic channel fluidically connecting the reaction chamber to the dry-reagent storage chamber.

### BRIEF DESCRIPTION OF THE DRAWINGS

For a better understanding of the present invention, some embodiments thereof are now described, purely by way of non-limiting example, with reference to the attached drawings, wherein:

FIG. 1 schematically illustrates an embodiment a Lab-On-Chip (LOC) system 1 according to an embodiment of the present invention;

FIG. 2A schematically illustrate a fluidic module A in a top-plan view according to an embodiment of the present invention;

FIG. 2B illustrate the fluidic module A in an exploded view;

FIGS. 3A-3B schematically illustrate the pathways followed by air and liquids inside the fluidic module A of FIG. 2A, during an exemplary analysis;

FIG. 4A schematically illustrates a portion of a reservoir module B of the cartridge 2, comprising a swab container;

FIG. 4B illustrates the swab container of FIG. 4A accommodating a swab;

FIG. 5A illustrates a different fluidic module A and the reservoir module B according to an embodiment of the present invention;

FIG. 5B illustrates a detail of a mechanical junction between the fluidic module A and the reservoir module B of FIG. 5A.

FIG. 6 illustrates another different fluidic module A and the reservoir module B according to another embodiment of the present invention;

FIG. 7 illustrate the fluidic module A in an exploded view according to another embodiment of the present invention.

### DETAILED DESCRIPTION

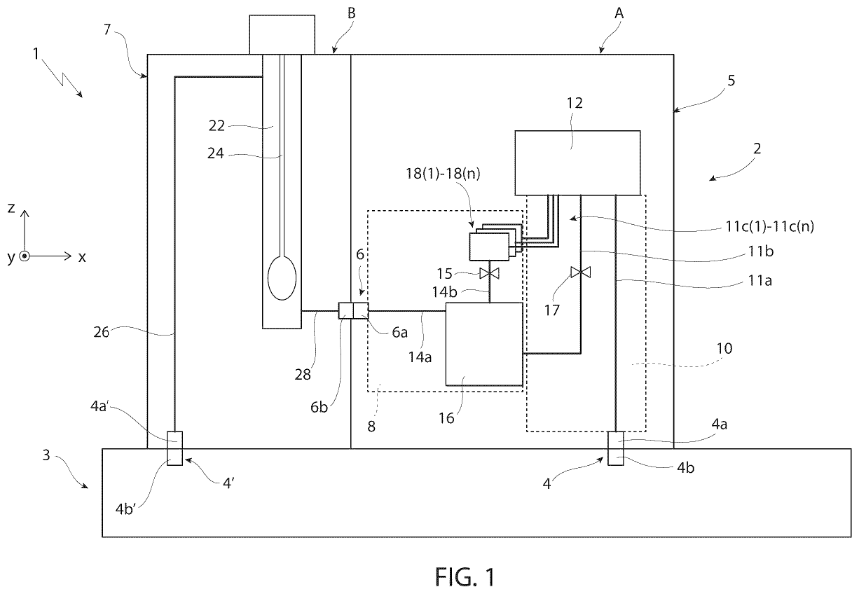

FIG. 1 schematically illustrates a non-limiting embodiment of a Lab-On-Chip (LOC) system 1. The LOC system 1 of the illustrated embodiment is configured to perform preparation steps of biological samples and to carry out, for example, a CRISPR analysis of a biological sample. However, the present invention is not limited to this application and can be used for different analyses such as Polymerase Chain Reaction (PCR), Loop-mediated isothermal amplification (LAMP), proteomic analyses, as well as analyses of non-biological samples, or even other applications. The biological or non-biological samples are, during the analysis, eluted in a water-based or oil-based liquid medium or fluid, or in any other liquid solution.

The LOC system 1 comprises a cartridge 2 connectable to a control machine 3 (the control machine 3 being not part of the present invention) through a first fluidic connection 4 and, optionally, a second fluidic connection 4′. For example, the control machine 3 is described in US2019/0201897. In an embodiment of the present invention the cartridge 2 is a disposable cartridge.

The control machine 3 is designed to control the movement of fluids inside the cartridge 2 and to carry out steps of sample treatment and analysis. For example, in an embodiment of the present invention the control machine 3 carries out thermal heating steps necessary for the CRISPR analysis to be performed on the biological samples inside cartridge 2.

According to the present invention, the cartridge 2 comprises a fluidic module A and a reservoir module B, fluidically connected to each other through a third fluidic connection 6 and mechanically coupled to each other. The fluidic module A is connectable to the control machine 3 through the first fluidic connection 4.

The reservoir module B is connectable to the control machine 3 through the second fluidic connection 4′. Alternatively to what has been described, the second fluidic connection 4′is not present and the reservoir module B is connected to the external environment through a fluidic connection (not shown) sealed by a water-proof membrane configured to allow air flow through it.

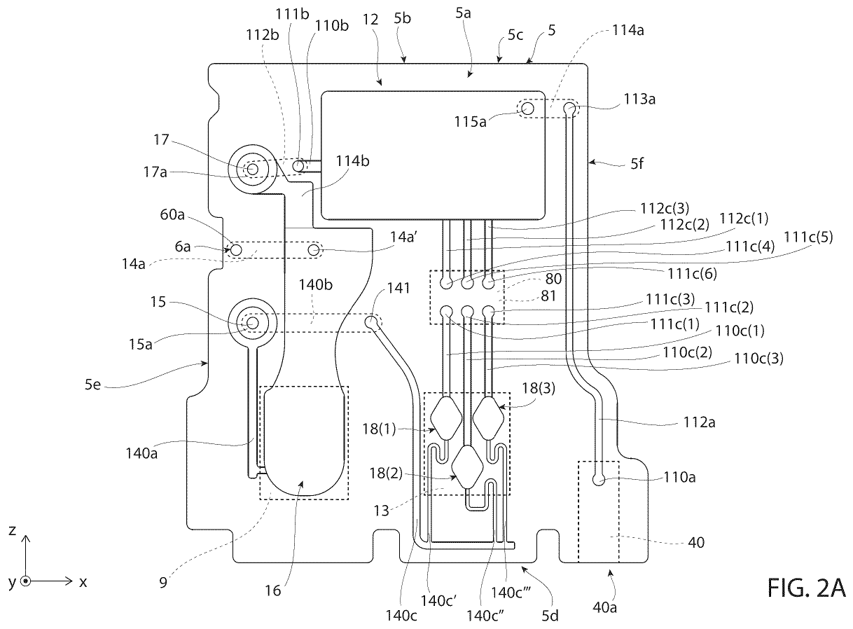

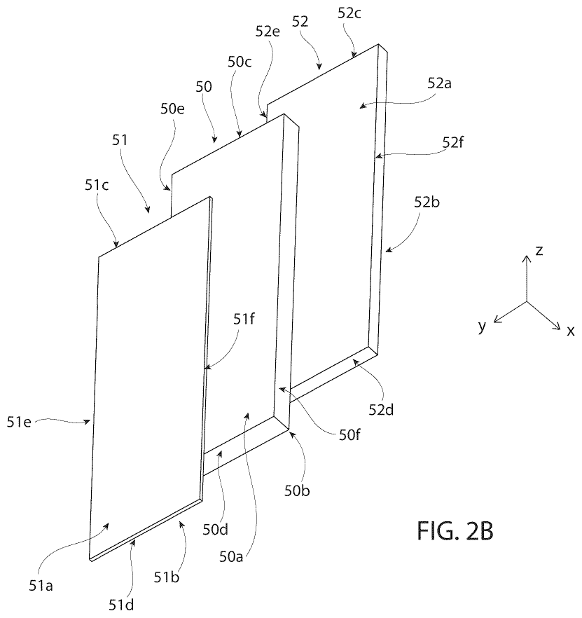

In one embodiment, the first fluidic connection 4 has a first portion 4a belonging to the fluidic module A and a second portion 4b belonging to the control machine 3. The first portion 4a and the second portion 4b are designed to couple and seal together. For example, the first portion 4a and the second portion 4b are male and female pneumatic connections, respectively (or vice versa). In an alternative embodiment, the connection type of the first fluidic connection 4 comprises a needle configured to fit into a rubber seat (e.g., 3D printed). In particular, the needle is part of the control machine 3 and the rubber seat is part of the fluidic module A, arranged within the cavity 40 of FIG. 2A.

The second fluidic connection 4′is formed analogously to the first fluidic connection 4 and comprises corresponding features (in particular a first portion 4a′, corresponding to portion 4a, and a second portion 4b′, corresponding to portion 4b).

The third fluidic connection 6 has a first portion 6a belonging to the fluidic module A and a second portion 6b belonging to the reservoir module B. The first portion 6a and the second portion 6b are designed to couple and seal together. For example, the first portion 6a and the second portion 6b are male and female Luer Slip connections, respectively (or vice versa).

In an embodiment, the fluidic module A includes a solid body 5, for example of a generally parallelepipedal or substantially quadrangular shape, which includes the first portion 4a of the first fluidic connection 4, the first portion 6a of the third fluidic connection 6, a fluidic circuit 8, a pneumatic circuit 10 and a storage chamber 12, configured to store (and in one embodiment, actually storing) desiccants, for example in the form of a bag containing silica beads or silica gel.

The fluidic circuit 8 includes a fluidic channel 14a, a fluidic channel 14b, a first valve 15, a lysis chamber 16 and one or more reaction chambers 18(1)-18(n). The fluidic channel 14a connects the first portion 6a of the third fluidic connection 6 to the lysis chamber 16. The fluidic channel 14b connects the lysis chamber 16 to the reaction chambers 18(1)-18(n). The valve 15 is located in the fluidic channel 14b. The opening and closing of the first valve 15 is controllable by the control machine 3 in a per se known manner. The valve 15 may be one among: a magnetic valve, a mechanical one-way valve, an elastomeric duckbill valve, a pneumatic valve, etc.

The pneumatic circuit 10 comprises air paths 11a, 11b, 11c(1)-11c(n) and a second valve 17. The air path 11a connects the first portion 4a of the first fluidic connection 4 to the storage chamber 12, the air path 11b connects the storage chamber 12 to the lysis chamber 16 and the air paths 11c(1)-11c(n) connect the storage chamber 12 to the reaction chambers 18(1)-18(n), respectively. The second valve 17 is located in the air path 11b. The opening and closing of the second valve 17 is controllable by the control machine 3 in a per se known manner. The valve 17 may be one among: magnetic valve, a mechanical one-way valve, an elastomeric duckbill valve, a pneumatic valve, etc.

The reservoir module B includes: a solid body 7 of generally parallelepipedal or substantially quadrangular shape, housing the second portion 6b of the third fluidic connection 6; a swab container or swab storage tube, 22 configured to hold or store (and in one embodiment, actually storing) liquid buffers and reagents and adapted to accommodate a swab 24 having a head or tip suitable for biological samples collection; a fluidic channel 26 configured to fluidically connect the swab container 22 to the second fluidic connection 4′or to the external environment, according to the respective embodiments mentioned above; a fluidic channel 28; and, when present, the first portion 4a′ of the second fluidic connection 4′.

The swab container 22 is connected to the second portion 6b of the third fluidic connection 6 via the fluidic channel 28.

FIG. 2A illustrates the fluidic module A in a triaxial system of axes x, y, z orthogonal to each other, in a top-plan view on the xz plane. FIG. 2B illustrates schematically the fluidic module A in an exploded view, in the triaxial system of axes x, y, z orthogonal to each other.

The solid body 5 of the fluidic module A is formed by three portions (illustrated in the exploded view in FIG. 2B), including a first portion 50, a second portion 51 and a third portion 52. The first portion 50 has a front face 50a and a back face 50b opposite to one another along the axis y, a top side 50c and a bottom side 50d opposite to one another along the axis z, a first lateral side 50e and a second lateral side 50f opposite to one another along the axis x. The front face 50a is connected to the back face 50b by the top side 50c, the bottom side 50d, the first lateral side 50e and the second lateral side 50f.

The second portion 51 has a front face 51a and a back face 51b opposite to one another along the axis y, a top side 51c and a bottom side 51d opposite to one another along the axis z, a first lateral side 51e and a second lateral side 51f opposite to one another along the axis x. The front face 51a is connected to the back face 51b by the top side 51c, the bottom side 51d, the first lateral side 51e and the second lateral side 51f.

The third portion 52 has a front face 52a and a back face 52b opposite to one another along the axis y, a top side 52c and a bottom side 52d opposite to one another along the axis z, a first lateral side 52e and a second lateral side 52f opposite to one another along the axis x. The front face 52a is connected to the back face 52b by the top side 52c, the bottom side 52d, the first lateral side 52e and the second lateral side 52f.

The second portion 51 is bonded to the first portion 50 at the front face 50a of the first portion 50; and the third portion 52 is bonded to the first portion 50 at the back face 50b of the first portion 50.

When portions 50-52 are bonded together, the back face 51b of the second portion 51 directly faces the front face 50a of the first portion 50, the front face 52a of the third portion 52 directly faces the back face 50b of the first portion 50. The front face 51a of the second portion 51 forms a front face 5a of the solid body 5; the back face 52b of the third portion 52 forms a back face 5b of the solid body 5; the top sides 51c, 50c and 52c form, as a whole, a top side 5c of the solid body 5; the bottom sides 51d, 50d and 52d form, as a whole, a bottom side 5d of the solid body 5; the first lateral sides 51e, 50e and 52e and the second lateral sides 51f, 50f and 52f form, as a whole, a first lateral side 5e and, respectively, a second lateral side 5f of the solid body 5.

The portions 50-52 are bonded together, for example glued or welded thermally, and may have gaskets and sealing means (not shown) to prevent leakage of liquids towards the outside, and to ensure separation of the various channels from each other and isolation from the external environment. In an embodiment, the second portion 51 is a transparent tape or film. The first portion 50 and the third portion 52 are, for example, of a plastic or polymeric material or of a bio-compatible material suitable for carrying out the above-mentioned biological analyses.

During use, when the cartridge 2 is connected to the control machine 3, the bottom face 5d of the solid body 5 faces the control machine 3 and the top face 5c faces away from the control machine 3.

The third portion 52 includes a cavity 40 at the bottom side 52d and on the front face 52a, having a main extension along the second axis z, towards the top side 52c.

The first portion 50 includes a first passing hole 110a extending through the first portion 50 from the back face 50b to the front face 50a, parallel to the first direction y. The first portion 50 further includes a second passing hole 113a extending through the first portion 50 from the back face 50b to the front face 50a, parallel to the first direction y. The first and the second passing holes 110a, 113a are at a distance from one another, in particular along the axis z.

When the third portion 52 is bonded to the first portion 50, the cavity 40 forms, at one end, an aperture 40a in the bottom side 5c of the solid body 5 and, at an opposite end, the cavity 40 faces the passing hole 110a.

The aperture 40a and the cavity 40 form, at least in part, the first portion 4a of the first fluidic connection 4 of FIG. 1.

The first portion 50 further includes a first air recess 112a at the front face 50a, located proximal to the lateral side 5f and having a main extension along axis z.

The first passing hole 110a connects the cavity 40 to the first air recess 112a.

When the second portion 51 is bonded to the first portion 50, the first air recess 112a forms part of the first air path 11a. The first air recess 112a extends from the passing hole 110a, parallel to the axis z, towards the top side 50c, up to the second passing hole 113a. The aperture 40a, the cavity 40, the first passing hole 110a, the first air recess 112a and the second passing hole 113a are located in a portion of the solid body 5 proximal to the lateral side 5f.

The third portion 52 includes a second air recess 114a at the front face 52a. When portions 50 and 52 are bonded together, the second passing hole 113a connects the first air recess 112a to the second air recess 114a. When the third portion 52 is bonded to the first portion 50, the second air recess 114a forms a further part of the first air path 11a. The second air recess 114a extends parallel to the axis x towards the lateral side 50e, reaching a third passing hole 115a that extends through the first portion 50 within the storage chamber 12. Therefore, the inside of the storage chamber 12 is in aerial connection with the aperture 40a, in particular when the second portion 51 is coupled to the first portion 50 and protects the inside of the storage chamber 12 from the outer environment.

A part of the second air path 11b is formed by a third air recess 110b extending at the front face 50a parallel to the axis x. The third air recess 110b departs from the storage chamber 12 at an opposite side of the storage chamber 12 with respect to the second air recess 114a.

The third portion 52 includes a fourth air recess 112b at the front face 52a, extending mainly along the x axis towards the lateral side 52e. The third air recess 110b is connected to the fourth air recess 112b by means of a passing hole 111b formed through the first portion 50.

The first portion 50 includes a valve hole 17a, which is a passing hole connecting the back face 50b to the front face 50a.

The fourth air recess 112b terminates in correspondence of the valve hole 17a of the first portion 50. The valve hole 17a houses the valve 17.

The first portion 50 further includes a lysis chamber 16, where a lysis step is performed during use, to extract nucleic acids from the cells present in the biological sample.

The first portion 50 also includes a recess 114b at the front face 50a, forming a further portion of the second air path 11b extending mainly along the axis z, towards the bottom side 50d, and connecting the valve hole 17a to the lysis chamber 16. A fluidic inlet hole 14a′ connects an upper portion of the lysis chamber 16 to the fluidic channel 14a. The fluidic channel 14a extends at the front face 52a of the third portion 52, parallel to the axis x, from the fluidic inlet hole 14a′ towards the first lateral face 5e of the solid body 5, terminating at the first portion 6a of the fluidic connection 6. The first portion 6a includes a passing hole 60a that is in fluidic continuity with the fluidic channel 14a. In particular, in the embodiment illustrated in FIG. 2A, the first portion 6a is a male Luer Slip connector.

The first portion 50 further includes fluidic recesses 140a and 140c, a valve hole 15a, a passing hole 141, and a plurality (here, three) of reaction chambers 18(1), 18(2), 18(3). The first portion 50 includes a fluidic recess 140b.

The fluidic recess 140a extends at the front face 50a, departing from a lower portion (opposite to the upper portion along the z axis) of the lysis chamber 16 and extending mainly parallel to the z axis towards the top side 50c of the first portion 50, terminating at the valve hole 15a. The valve hole 15a is a passing hole connecting the front face 50a and the back face 50b and housing the valve 15. The fluidic recess 140b extends at the front face 52a of the third portion 52, with a main extension that is substantially parallel to the x axis. When the portions 50 and 52 are bonded together, the fluidic recess 140b faces at one end the valve hole 15a and at the opposite end the passing hole 141. The fluidic recess 140c extends at the front face 50a of the first portion 50, from the passing hole 141 towards the bottom side 50d of the first portion 50, where it forms three ramifications 140c′, 140c″ and 140c″′, each of them reaching one respective reaction chamber 18(1), 18(2) and 18(3).

The fluidic recess 140a, the valve hole 15a, the fluidic recess 140b, the passing hole 141 and the fluidic recess 140c form, as a whole, the fluidic channel 14b of FIG. 1.

When the portions 50-52 are bonded together, the lysis chamber 16 and the reaction chambers 18(1), 18(2) and 18(3) are sealed on one side by the second portion 51, and on the other, opposite, side by the third portion 52. In an embodiment, the third portion 52 houses two heaters 9, 13 (of a per se known type). When the first portion 50 and the third portion 52 are bonded together, one heater 9 is arranged in correspondence of the lysis chamber 16 and the other heater 13 is arranged in correspondence of the reaction chambers 18(1), 18(2) and 18(3). The heater 9 is controllable by the control machine 3 to perform heating steps of the lysis chamber, for example at a temperature of 95° C. for a time of 5 minutes in order to extract nucleic acids from the cells present in the biological sample during the exemplary CRISPR analysis. The heater 13 is controllable by the control machine 3 to maintain the reaction chambers 18(1)-18(3) at a fixed temperature, for example of 37° C.

The temperatures achieved by heaters 9 and 13 may be different from the above examples, based on the specific analysis to be performed.

The first portion 50 also includes a plurality (here, three) of fluidic recesses 110c(1), 110c(2), 110c(3), a plurality (here, six) of passing holes 111c(1)-111c(6), and a plurality (here, three) of air recesses 112c(1), 112c(2), and 112c(3). The third portion 52 also includes a recess 80, for example of rectangular shape, housing a membrane 81 permeable to gases and vapors and impermeable to liquids. The membrane 81 is for example a layer of material impermeable to liquids (waterproof fabric) but permeable to air and vapor (breathable fabric), for example a PTFE membrane.

Alternatively to a membrane 81, an equivalent permeable film may be used (for example a film provided with holes or a permeable PDMS layer).

The fluidic recesses 110c(1), 110c(2), 110c(3) extend at the front face 50a of the first portion 50 with a main extension that is substantially parallel to the z axis. The fluidic recesses 110c(1), 110c2) and 110c(3) depart from respective upper portions of the reaction chambers 18(1), 18(2) and 18(3), and reach the passing holes 111c(1), 111c(2) and 111c(3), respectively. Passing holes 111c(1), 111c(2) and 111c(3) connect the front face 50a with the back face 50b of the first portion 50. The passing holes 111c(4), 111c(5) and 111c(6) are located at a distance, along the axis z, from passing holes 111c(1), 111c(2) and 111c(3), such that passing holes 111c(4), 111c(5) and 111c(6) are closer to the top side 50c of the first portion 50 than the passing holes 111c(1), 111c(2) and 111c(3). Moreover, the passing holes 111c(4), 111c(5) and 111c(6) are substantially aligned along the axis z with passing holes 111c(1), 111c(2) and 111c(3), respectively.

Air recesses 112c(1), 112c(2) and 112c(3) extend at the front face 50a of the first portion 50, with a main extension substantially parallel to the axis z, connecting respectively the passing hole 111c(4) with storage chamber 12, the passing hole 111c(5) with storage chamber 12 and the passing hole 111c(6) with storage chamber 12. When the first portion 50 and the third portion 52 are bonded together, the recess 80 faces the passing holes 111c(1)-111c(6), in such a way that the membrane 81 fluidically connects passing holes 111c(1)-111c(3) with passing holes 111c(4)-111c(5).

Fluidic recesses 110c(1)-110c(3), passing holes 111c(1)-111c(3), the membrane 81 in the recess 80, passing holes 111c(4)-111c(6) and air recesses 112c(1)-112c(3), as a whole, form the air paths 11c(1)-11c(n) of FIG. 1, connecting reaction chambers 18(1)-18(n) to the storage chamber 12.

Reaction chambers 18(1)-18(n) are configured to store (and, in one embodiment, they store) freeze-dried or lyophilized reagents before their use for the analysis of the sample. In the non-limiting example described herein, the reaction chambers 18(1)-18(n) are configured to store (and, in one embodiment, they store) lyophilized enzymes necessary to perform steps of the CRISPR analysis. In another non-limiting example (not described) the reaction chambers 18(1)-18(n) are configured to store (and, in one embodiment, they store) lyophilized antibodies and enzymes necessary to perform steps of an ELISA analysis in a per se known manner. In another non-limiting example (not described) the reaction chambers 18(1)-18(n) are configured to store (and, in one embodiment, they store) lyophilized antibodies immobilized on magnetic beads necessary to perform steps of protein biosensing in a per se known manner. In another non-limiting example (not described) the reaction chambers 18(1)-18(n) are configured to store (and, in one embodiment, they store) lyophilized reagents necessary to perform steps of a PCR analysis in a per se known manner. It is evident that other applications are possible, where the reaction chambers 18(1)-18(n) can be configured to store (and in one embodiment, actually store) specific lyophilized, or dry, or dried or solid reagents to be exploited in steps of an analysis performed by system 1 during use.

During shelf-life of the fluidic module A of the cartridge 2, when the storage chamber 12 stores the desiccant and the reaction chambers 18(1)-18(n) store the dry, or dried, or lyophilized, or solid reagents (referred to as “dry reagents” in the following), the desiccant prevents hydration of said reagents. The prevention of hydration improves the life-span of the dry reagents and therefore of the fluidic module A in general, as compared to a case in which the desiccant is arranged in an external package, which in turn contains the fluidic module A. Indeed, the presence of the desiccant inside storage chamber 12 allows capturing water vapor that may (even by chance) reach the fluidic module A from an external environment before packaging of the fluidic module A or during shelf-life of the fluidic module A.

During use of the cartridge 2, the desiccant in the storage chamber 12 further protects the dry reagents from hydration during bio-analysis steps, when liquids flow in the fluidic module A, but said reagents still need to be kept dry.

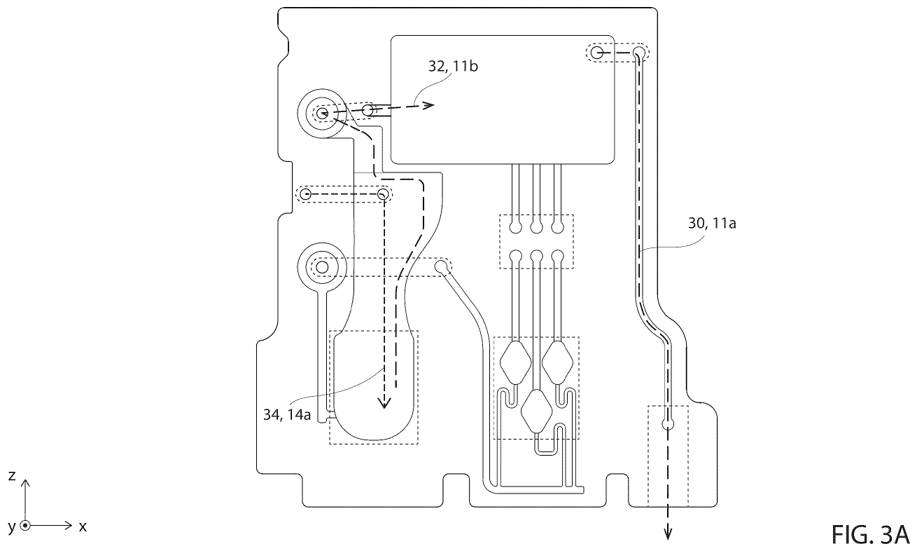

FIG. 3A schematically illustrates the pathways followed by air and liquids inside the fluidic module A illustrated in FIG. 1 and in FIG. 2A, for example during above mentioned CRISPR analysis performed on the biological sample. In the illustrated phase of the analysis, fluidic module A is connected to reservoir module B (not shown) through the fluidic connection 6, and fluidic module A is connected to the control machine 3 (not shown) through the fluidic connection 4.

The control machine 3, in the phase of FIG. 3A, opens the valve 17 and closes the valve 15. Moreover, the control machine 3 sucks air from the fluidic module A through the fluidic connection 4, generating an air flow 30 along the air path 11a. The air flow 30 recalls air from the storage chamber 12, generating a negative pressure inside the storage chamber 12. The negative pressure in storage chamber 12 recalls air from the lysis chamber 16 along the air path 11b and the opened valve 17, giving rise to an air flow 32. The air flow 32 generates a negative pressure in the lysis chamber 16. The negative pressure in the lysis chamber 16 recalls liquids (in the illustrated example the biological sample to be analyzed plus liquid buffers and reagents) from the reservoir module B through the fluidic connection 6 and the fluidic channel 14a, generating a liquid flow 34. The liquid flow 30 at least in part fills the lysis chamber 16.

In the described embodiment, the control machine 3 then controls the heater 9 to perform a heat-up step. During the heat-up step, the liquid in the lysis chamber 16 is heated at high temperature, for example in the range 90-99° C., for example 95° C., and kept at said temperature for example for 3-10 minutes, for example 5 minutes, to extract nucleic acids from cells present in the biological samples. During the heat-up step, part of the liquids evaporates. The evaporated liquids, in form of vapor, exit the lysis chamber 16 through the air path 11b. The vapor is, at least in part, captured by the desiccant in the storage chamber 12 and optionally, at least in part, extracted by the control machine 3 through the air path 11a, thus preventing premature hydration of the dry reagents stored in reaction chambers 18(1)-18(n).

FIG. 3B illustrates a subsequent phase of the analysis. In the phase of FIG. 3B, the control machine 3 closes the valve 17 and opens the valve 15. Moreover, the control machine 3 sucks air from the fluidic module A through the fluidic connection 4, generating the air flow 30 through the air path 11a. The air flow 30 recalls air from the storage chamber 12, generating the negative pressure inside the storage chamber 12. The negative pressure in storage chamber 12 recalls air from the reaction chambers 18(1)-18(3) along the air paths 11c(1)-11c(3), generating air flows 36(1)-36(3) in the air paths 11c(1)-11c(3), respectively. The air flows 36(1)-36(3) generate negative pressures in the reaction chambers 18(1)-18(3). The negative pressures in the reaction chambers 18(1)-18(3) recall the liquids from the lysis chamber 16 through the fluidic path 14b and through the opened valve 15, generating a liquid flow 38. The liquid flow 38 separates in three streams 38′, 38″ and 38″′ reaching and filling, at least in part, the reaction chambers 18(1)-18(3) respectively, and hydrating the dry reagents stored in said reaction chambers. In the described embodiment, the control machine 3 then controls the heater 13 to maintain a fixed temperature, for example of 37° C., in the reaction chambers 18(1)-18(3) to perform a step of the CRISPR analysis in a per se known manner. During this phase, the liquids can completely fill the reaction chambers 18(1)-18(3) and in part fill the air paths 11c(1)-11c(3) up to the membrane 81. The membrane 81 (being, as said, waterproof) prevents the liquids from reaching the storage chamber 12, emptying the reaction chambers 18(1)-18(3). In this way, the membrane 81 also prevents the contact between the liquids and the desiccant stored inside storage chamber 12, thus avoiding undesired absorption and any possible contamination (or degradation) of the sample to be analyzed that may result from the contact of said sample with the desiccant. It is noted that during this phase, the valve 17 remains closed, preventing the liquids to flow in the storage chamber 12 along the air path 11b.

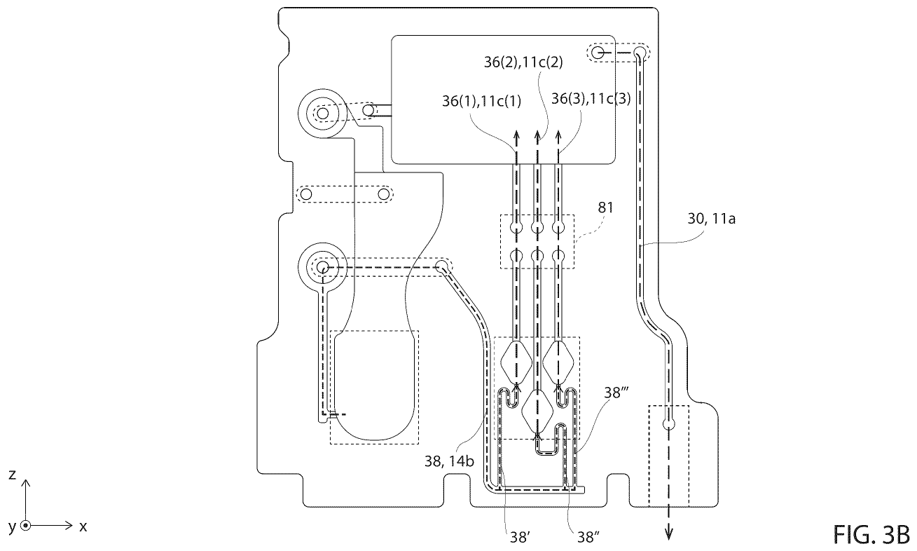

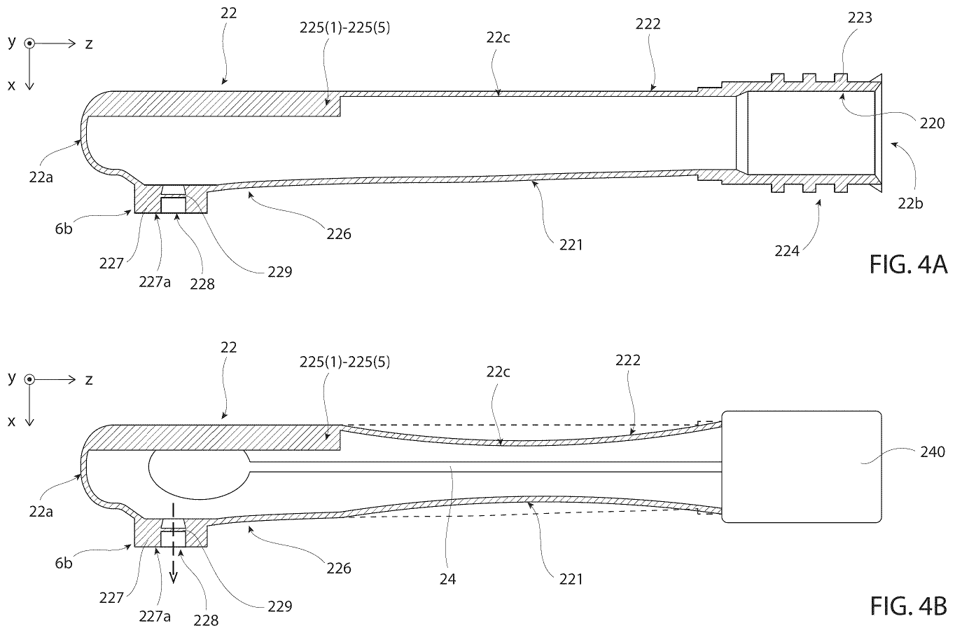

FIG. 4A illustrates a portion of an embodiment of the reservoir module B of the cartridge 2, comprising the swab container 22.

The swab container 22 is, in one embodiment, of a bio-compatible plastic material. In a non-limiting example, the swab container 22 is made of polypropylene and it is fabricated exploiting technological processes known in the art for the fabrication of medical packaging.

The swab container 22 has substantially the shape of a hollow cylinder, terminating with a generally round bottom wall 22a at one end, a generally round opening 22b at an opposite end, and a solid lateral wall 22c connecting the bottom wall 22a with the opening 22b. The lateral wall 22c includes an inner surface 220 facing the inside of the hollow cylinder and an outer surface 222, opposite to the inner surface 220, facing outside of the cylinder.

In the illustrated embodiment, the lateral wall 22c comprises a portion 224 proximal to the opening 22b, the portion 224 including a male thread 223 on the outer surface 222.

In another embodiment (not illustrated) a female thread is present on the inner surface 220 in the portion 224 instead of the male thread 223 on the outer surface 222.

A portion 226 of the swab container 22, proximal to the bottom wall 22a, houses, on the inner surface 220, a plurality of protrusions or fins 225(1)-225(5). The fins 225(1)-225(5) protrude inward from the inner surface 220 radially towards the main axis of the cylinder. In an embodiment, the fins 225(1)-225(5) extend longitudinally along the cylinder. In one embodiment, the fins 225(1)-225(5) reach the bottom wall 22a; in another embodiment, the fins 225(1)-225(2) are at a distance from the bottom wall 22a.

The swab container 22 further includes a protrusion 227 extending outward from a sub-portion of the portion 226 at the outer surface 222, in particular in proximity of the bottom wall 22a. The protrusion 227 terminates with a surface 227a, for example a flat surface. A passing hole 228 extends from the surface 227a towards the inside of the cylinder, connecting the surface 227a with the inner surface 220.

In an embodiment, the protrusion 227 and the passing hole 228 form, together, the second portion 6b of the fluidic connection 6. In particular, the protrusion 227 and the passing hole 228 form a female Luer Slip connector.

Before use, the passing hole 228 may be sealed by a breakable membrane 229. The breakable membrane 229 is configured to break when the reservoir module B is coupled to the fluidic module A, fluidically connecting the inside of the swab container 22 with the fluidic channel 14a.

A portion 221 of the swab container 22 comprised between the portion 226 and the portion 224 is more flexible and elastic, for example by making it thinner, than the portions 224 and 226, so that only the portion 221 bends or deforms inwardly under the negative pressure generated by the control machine 3 to recall the liquids from module B (generating the previously mentioned liquid flow 34). By modulating the pressure generated by the control machine 3, it is possible to tune the degree of deformation of the portion 221, and even invert the direction of flow 34 (as well as flows 38), if required.

For example, the thicker portions 224 and 226 have a thickness in the range 1-1.5 mm and the thinner portion 221 has a thickness in the range 0.4-1 mm, in particular 0.5-0.6 mm.

FIG. 4B illustrates the swab container 22 accommodating the swab 24. In the illustrated embodiment, the swab 24 is coupled to, or integral with, a female threaded cap 240. The female threaded cap 240 is couplable to the thread 223. When the swab 24 is inserted in the swab container 22 and the female threaded cap 240 is screwed on the male thread 223, the inside of the swab container 22 is effectively isolated from the external environment and the tip of the swab is squeezed by the fins 225(1)-225(5), releasing the biological material previously collected by the tip. The biological material released by the squeezing action elutes into a liquid buffer or liquid medium contained inside the swab container 22. The liquid buffer or medium can be manually inserted into the swab container, or it can be pre-stored into the swab container during manufacturing of the same.

In another embodiment (not illustrated) when a female thread is present on the inner surface 220 instead of the male thread 223 on the outer surface 222 of the swab container, the swab 24 is coupled to, or integral with, a male threaded cap.

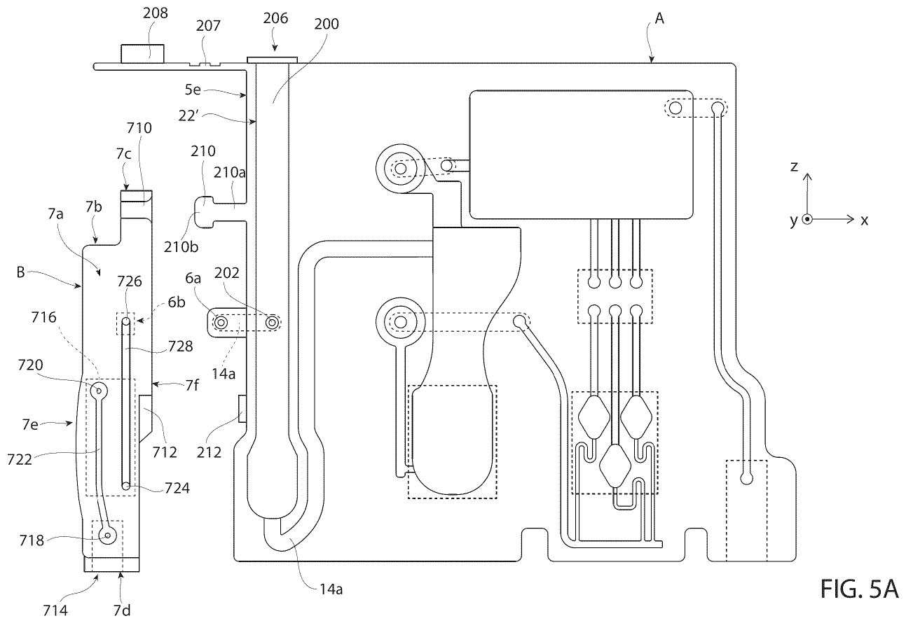

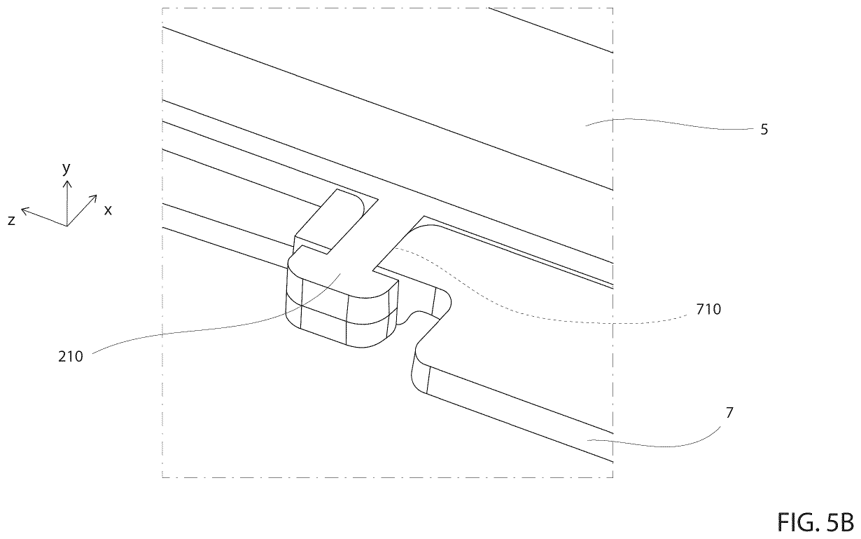

FIG. 5A-5B illustrate a different embodiment of the present invention. In FIGS. 5A-5B, elements of the fluidic module A and/or of the reservoir module B that are in common with the fluidic module A and/or the reservoir module B of FIGS. 1-4 are indicated with the same reference numerals and are not further described.

In the embodiment illustrated in FIG. 5A-5B, the fluidic module A further includes an integrated swab container 22′; the fluidic module A and the swab container 22′are monolithic or a single piece.

With reference to FIG. 2A, and as shown in FIG. 5A, the swab container 22′extends as a continuation of the lateral side 5e. To accommodate the swab container 22′at the lateral side 5e, guaranteeing a proper fluidic connection with the fluidic circuit 8, the first portion 6a of the fluidic connection 6 is, in the embodiment of FIG. 5A, formed lateral to the swab container 22′, fluidically coupled to the swab container as better described in the following. That is to say that the swab container 22′extends between the first portion 6a of the fluidic connection 6 and the passing hole 14a′. The lateral side 5e of the solid body 5 is, in this embodiment, a lateral side of the swab container 22′.

The swab container 22′includes a recess 200, an aperture 206 at one end of the recess 200 to insert the swab, a passing hole 202 forming an inlet point for a buffer solution, during use.

The recess 200 extends at the front face 50a of the first portion 50, with a main dimension substantially parallel to the axis z between the top side 50c (where the aperture 206 is present) and the bottom side 50d of the first portion 50 (without reaching the bottom side 50d). When the first portion 50 and the second portion 51 are bonded together, the recess 200 forms the swab container 22′.

The passing hole 202 connects the front face 50a to the back face 50b of the first portion 50.

The first portion 6a of the fluidic connection 6 is formed on a physical support that protrudes from the lateral side 5e of the swab container 22′. The passing hole 202 is fluidically connected to the first portion 6a.

The swab container 22′ is fluidically connected to the lysis chamber 16 through the fluidic channel 14a.

In an embodiment, a plastic cap 208 is attached to the solid body 5 through a flexible mechanical junction 207, the cap 208 being adapted to seal the aperture 206 when the swab is accommodated in the swab container 22′. In another embodiment (not illustrated), a cap suitable for sealing the aperture 206 is integral with a swab at one end of a stick, or shaft, of said swab. In yet another embodiment, a cap suitable for sealing the aperture 206 is detachable from the solid body 5 and from the swab shaft.

In an embodiment, the fluidic module A further includes one or more protruding mechanical connectors (in the following, also named “pins”) 210 and one or more protruding guides 212, for example in the form of inclined planes with respect to the surface of the front face 5a of the solid body 5. One pin 210 is shown in FIGS. 5A and 5B.

The pin 210 includes a body 210a and a head 210b and is, for instance, mushroom-shaped or T-shaped. The body 210a of the pin 210 extends at the first lateral side 5e of the swab container 22′, away from the first lateral side 5e with a main dimension parallel to the axis x. The head 210b extends at one end of the body 210a opposite to another end of the body 210a that is physically coupled to the lateral side 5e. In one example, the main dimension of the head 210b is transverse to the main dimension of the body 210a, so that the head 210b laterally projects, or laterally protrudes, from the body 210a. The lateral projections of the head 210b form, as better explained later, an interlocking mechanism that is used to maintain in a fixed position the reservoir module B, when the reservoir module B is coupled to the fluidic module A in the embodiment of FIG. 5A.

The protruding guide 212 likewise extends at the first lateral side 5e of the body 5, at a distance from the pin 210. The protruding guide 212 has the function of favoring the alignment of the reservoir module B, when the reservoir module B is to be coupled to the fluidic module A in the embodiment of FIG. 5A. The protruding guide 212 also functions as blockage means to avoid detachment of the reservoir module B from the fluidic module A (and vice versa).

The solid body 7 of the reservoir module B has a front face 7a and a back face 7b opposite to one another along the axis y, a top side 7c and a bottom side 7d opposite to one another along the axis z, a first lateral side 7e and a second lateral side 7f opposite to one another along the axis x. The front face 7a is physically connected to the back face 7b by the top side 7c, the bottom side 7d, the first lateral side 7e and the second lateral side 7f.

The solid body 7 includes one or more openings or slits or sockets 710 adapted to be physically coupled with the one or more pins 210 of the fluidic module A. For instance, the opening 710 is formed as a trench at the front face 7a and extends from the first lateral side 7e to the second lateral side 7f. The opening 710 has dimensions that match with the body 210a, so that the body 210a can be inserted within the opening 710 and the projections of the head 210b come into contact with the first lateral side 7e.

The body 210a can act as a pivot point to facilitate the alignment and coupling of the reservoir module B with the fluidic module A.

The solid body 7 also includes one or more protruding guides 712 (for example one or more inclined planes) on the second lateral side 7f, configured to couple with the corresponding side of the fluidic module A, to couple with the protruding guides 212.

As a consequence of the above-described embodiment, when the fluidic module A and the reservoir module B are coupled together, the pin 210 engages in the socket formed by the opening 710, creating a mechanical junction between the fluidic module A and the reservoir module B (see FIG. 5B). Moreover, when the fluidic module A and the reservoir module B are coupled together, the protruding guide 712 is pressed on the protruding guide 212 until the protruding guide 712, by bending the protruding guide 212, snaps below the protruding guide 212. In other words, the guides 212 and 712 operates as a snap mechanism.

The mechanical connection provided by the pin 210 when engaged in the opening 710, and by the protruding guides 212, 712, allows a precise alignment and avoids undesired relative movements between the two modules A and B.

In another embodiment (not illustrated) the one or more pins 210 are on the reservoir module B, and the one or more openings 710 are on the fluidic module A.

In the embodiment of FIG. 5A, the solid body 7 of reservoir module B includes: an air inlet 714 (forming at least in part the first portion 4a′ of the second connection 4′, previously described), a reservoir chamber 716, a passing hole 718, a passing hole 720, an air channel 722, a passing hole 724, a passing hole 726, and a fluidic channel 728.

The air inlet 714 is formed by a cavity extending at the bottom side 7d of the solid body. The passing hole 718 connects the air inlet 714 to the air channel 722. The air channel 722 extends at the front face 7a of the solid body 7, connecting the passing hole 718 to the passing hole 720. The passing hole 720 connects the air channel 722 to the reservoir chamber 716. The passing hole 720 is located in a region of the reservoir chamber 716 that cannot be reached, during use, by the liquid solution/buffer contained within the reservoir.

The reservoir chamber 716 extends at the back face 7b of the solid body 7. The reservoir chamber 716 is sealed for example by a film, or by a plastic wall bonded or glued to the back surface 7b of the solid body 7.

The passing hole 724 connects the reservoir chamber 716 to the fluidic channel 728. The fluidic channel 728 extends at the front face 7a of the solid body 7, connecting the passing hole 724 to the passing hole 726. The second passing hole 726 connects the fluidic channel 728 to the second portion 6b of the fluidic connection 6.

The passing hole 718, the air channel 722, the passing hole 720, the passing hole 724, the fluidic channel 728 and the passing hole 726 are sealed for example by a transparent tape or film, or a plastic wall bonded or glued at the front face 7a of the solid body 7, protecting them from the external environment and preventing leakages of liquids.

When the fluidic module A and the reservoir module B are coupled together, the alignment provided by the pin 210 with the opening 710 and by the protruding guides 212, 712 further ensures the correct coupling between the first portion 6a and the second portion 6b of the fluidic connection 6. A breakable membrane or a removable cap may be present to seal the second portion 6b in order to prevent liquid leakages before use. The breakable membrane can be configured to break when the second portion 6b is coupled to the first portion 6a.

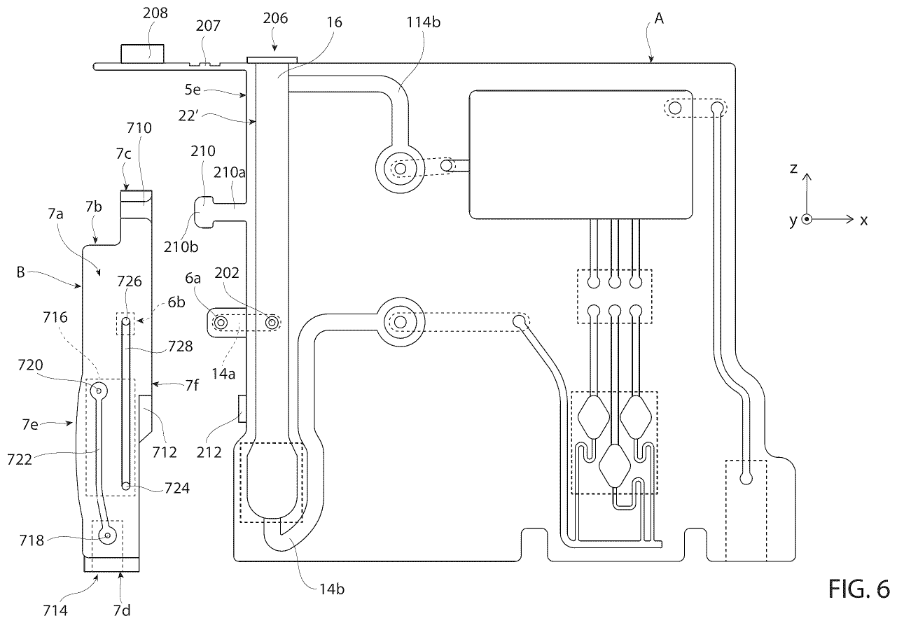

FIG. 6 shows a further embodiment of the present invention. In FIG. 6, the reservoir module B is the same as already described and shown for FIG. 5A. However, differently from FIG. 5A, in FIG. 6 the lysis chamber 16 extends reaching the top side 5c of the solid body 5 and is configured (shaped) to house the swab 24. In other words, the swab container 22′ and the lysis chamber 16 are formed by one, common, recess fluidically connected to the reaction chambers 18(1)-18(N) through the fluidic channel 14b.

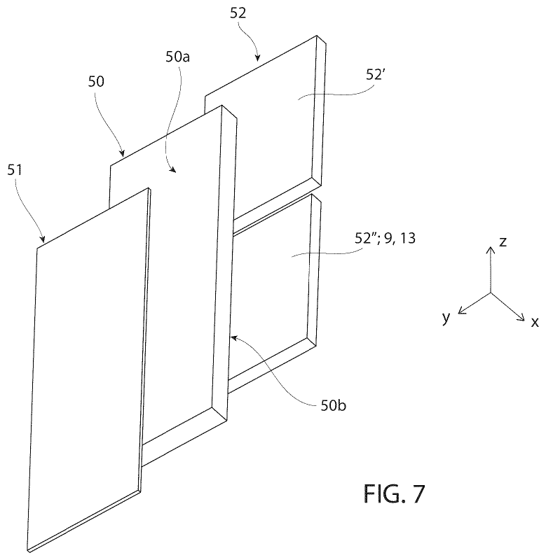

According to a further embodiment of the present invention, shown in FIG. 7, the solid body 5 of the fluidic module A is formed by three portions (illustrated in the exploded view in FIG. 7), including the first portion 50, the second portion 51 and the third portion 52. Differently from the embodiments previously described, in the embodiment of FIG. 7 the second portion 51 and the third portion 52 include respective tapes or films. In particular, the third portion 52 may be formed by a plurality of parts, in particular including a film or a tape portion 52′and one or more portions 52″ of semiconductor material (e.g., silicon), glued and/or mechanically plugged to the first portion 50.

In this embodiment, the elements described previously as part of the third portion 52, are instead formed on the back face 50b of the first portion 50. The front face 50a of the first portion 50 is as previously described. The elements formed at the back face 50b of the first portion 50 include, in particular, the second air recess 114a, the fourth air recess 112b, the fluidic channel 14a, the fluidic recess 140b, the recess 80 (housing the membrane 81). Furthermore, cavity 40 extends at the bottom face 50d of the first portion 50.

The one or more portions 52″ of semiconductor material, being part of the third portion 52, form the heaters 9, 13.

It is noted that, the fluidic module A and the reservoir module B of cartridge 2, in all embodiments disclosed, are suitable for storing, before use, dry reagents (in module A) and liquid buffer/reagents (in module B). More in detail, the fluidic module A is configured to store dry reagents in an environment with controlled humidity, as provided by the presence of the desiccant in the storage chamber 12; the reservoir module B is configured to store the liquids in the reservoir chamber 716 or in the swab container 22 (according to the respective embodiments). Fluidic module A is couplable to reservoir module B. Since the fluidic module A is a separate physical entity with respect to the reservoir module B, the present invention allows for the fabrication of the two modules A and B according to respective, separate, processes, even in different fabrication environments or plants. For example, the fabrication and packaging of the fluidic module A can be performed in a controlled environment with low relative humidity, reducing the possible sources of contamination or undesired hydration of the dry reagents. The fabrication and packaging of the reservoir module B may instead be carried out in an environment with looser constraints, therefore limiting the production costs. Moreover, different technologies may be exploited for the fabrication of the fluidic module A with respect to the fabrication of the reservoir module B.

1. A cartridge for Lab-On-Chip applications, comprising:
a first module including:
at least one desiccant storage chamber;
a dry-reagent storage chamber;
a fluidic circuit, fluidically connected to the dry-reagent storage chamber;
a first air path connecting the dry-reagent storage chamber to the at least one desiccant storage chamber and comprising a membrane that is impermeable to liquids and permeable to gases and vapors, the membrane being arranged in the first air path in such a way to prevent liquid flow from the dry-reagent storage chamber to the at least one desiccant storage chamber;
a second module including a container having an internal cavity for holding a liquid solution;
wherein the first module and the second module have a respective first fluidic connector and second fluidic connector adapted to be fluidically coupled to one another; and
wherein the first fluidic connector of the first module is fluidically coupled to the fluidic circuit and the second fluidic connector of the second module is fluidically coupled to the container.

2. The cartridge for Lab-On-Chip applications of claim 1, further comprising one or more desiccants in the at least one desiccant storage chamber and one or more dry reagents in the dry-reagent storage chamber.

3. The cartridge for Lab-On-Chip applications of claim 1, wherein the first module comprises a first layer and a second layer coupled to one another;
wherein the first air path comprises:
a first portion in the first layer, fluidically connected to the dry-reagent storage chamber;
a second portion in the second layer;
a third portion in the first layer, fluidically connected to the at least one desiccant storage chamber;
a first through hole extending through the first layer, fluidically connected to the first portion of the first air path and aerially coupled to the second portion of the first air path via the membrane; and
a second through hole extending through the first layer, fluidically connected to the third portion of the first air path and aerially coupled to the second portion of the first air path via the membrane.

4. The cartridge for Lab-On-Chip applications of claim 1, wherein the first module comprises a first layer having a first face and a second face opposite to one another;
wherein the first air path comprises:
a first portion at the first face of the first layer, fluidically connected to the dry-reagent storage chamber;
a second portion at the second face of the first layer;
a third portion at the first face of the first layer, fluidically connected to the at least one desiccant storage chamber;
a first through hole extending through the first layer from the first face to the second face, fluidically connected to the first portion of the first air path and aerially coupled to the second portion of the first air path via the membrane; and
a second through hole extending through the first layer from the first face to the second face, fluidically connected to the third portion of the first air path and aerially coupled to the second portion of the first air path via the membrane.

5. The cartridge for Lab-On-Chip applications of claim 4, wherein the first module comprises a second layer and a third layer;
wherein the second layer includes a tape or film coupled to the first face of the first layer, configured to seal the fluidic circuit, the at least one desiccant storage chamber, and the dry-reagent storage chamber; and
wherein the third layer includes at least one tape or film coupled to the second face of the first layer and at least one heating element of semiconducting material coupled to the second face of the first layer.

6. The cartridge for Lab-On-Chip applications of claim 1, wherein the first module and the second module have respective mechanical coupling means for mechanically coupling the first module to the second module.

7. The cartridge for Lab-On-Chip applications of claim 1, wherein the first fluidic connector and second fluidic connector are Luer connectors.

8. The cartridge for Lab-On-Chip applications of claim 1, wherein the container is a sample collection container comprising a swab having a tip, a shaft coupled to the tip, and a cap coupled to shaft;
wherein the container has a threaded opening for insertion of the swab in the internal cavity;
wherein the cap of the swab is a threaded cap suitable for sealing the internal cavity when the swab is inserted in the container and the threaded cap is screwed on the threaded opening; and
wherein the container includes a first portion of deformable material configured to undergo an elastic deformation when an internal pressure is exerted.

9. The cartridge for Lab-On-Chip applications of claim 8, wherein the container includes a second portion provided with protrusions inside the internal cavity such that, when the swab is inserted into the container, the tip comes in contact with the protrusions; and
wherein the second portion being configured to be withstand said internal pressure without deformation.

10. The cartridge for Lab-On-Chip applications of claim 9, wherein the second fluidic connector includes a passing hole through the container at said second portion, said elastic deformation being caused, during use, by pumping the liquid solution out of the container.

11. The cartridge for Lab-On-Chip applications of claim 1, further comprising a second air path, aerially connecting the at least one desiccant storage chamber to an outlet opening of the cartridge, said outlet opening being configured for being connected to external control means for air sucking.

12. The cartridge for Lab-On-Chip applications of claim 1, further comprising a sealing layer coupled to the first module to seal the fluidic circuit, the at least one desiccant storage chamber, and the dry-reagent storage chamber.

13. The cartridge for Lab-On-Chip applications of claim 1, wherein the fluidic circuit includes:
a reaction chamber;
a first fluidic channel fluidically connecting the first fluidic connector to the reaction chamber; and
a second fluidic channel fluidically connecting the reaction chamber to the dry-reagent storage chamber.
